(19) United States
(12) Patent Application Publication
(10) Pub. No.: US 2013/0176419 A1
(43) Pub. Date: Jul. 11, 2013

(54) APPARATUS AND METHOD FOR MANUALLY CONFIRMING ELECTRONICALLY STORED INFORMATION REGARDING A PIECE OF LUMBER

(71) Applicant: Baxley Equipment Co., Hot Springs, AR (US)

(72) Inventors: Pat Conry, Hot Springs, AR (US); Chris Raybon, Hot Springs, AR (US); Russell R. Kennedy, Hot Springs, AR (US)

(73) Assignee: BAXLEY EQUIPMENT CO., Hot Springs, AR (US)

(21) Appl. No.: 13/731,171

(22) Filed: Dec. 31, 2012

Related U.S. Application Data
(60) Provisional application No. 61/582,538, filed on Jan. 3, 2012.

(51) Int. Cl. G03B 21/14; H04N 5/74

(52) U.S. Cl. CPC G03B 21/142; H04N 5/74
USPC 348/86; 353/121; 353/28

(57) ABSTRACT

Provided are an apparatus and a method for manually confirming the accuracy of electronically stored information regarding a piece of lumber.

This application claims priority to U.S. Provisional Patent Application Ser. No. 61/582,538, filed 3 Jan. 2012, the complete disclosure of which is incorporated herein by reference.

### FIELD OF THE INVENTION

The invention relates to an apparatus and method for manually confirming the accuracy of electronically stored information regarding a piece of lumber.

### BACKGROUND OF THE INVENTION

In the lumber business, there has been developed scanning equipment that determines, visually and otherwise, the grade of lumber. These machines are more accurate than the previous method of manual inspectors. However, the automated systems are naturally subject to malfunctions, etc. and require manual inspections of test samples to confirm the accuracy of the electronically stored information. Examples of such scanning equipment is disclosed in U.S. Pat. No. 5,412,220 (Moore); U.S. Pat. No. 6,031,567 (Johnson); and U.S. Pat. No. 7,900,663 (Huang), the complete disclosures of which are incorporated herein by reference.

The Moore patent discloses a method to grade lumber, which can be automated, in which the lumber is scanned into a computer as it passes under scanners, and the grade of the lumber and pictures of the lumber are electronically stored information. Quick manual confirmation of the electronic information stored in the computer regarding a particular piece of lumber is difficult to perform.

One method is to manually pullout a random sample, inspect it manually, then reenter it into the system. This is very difficult at production pace and is not very feasible. A better method is to affix a mark (paint or dye) on a board indicating the grade and have an online lumber inspector (person) verifying the grade is proper. That system is in operation, and also has drawbacks. For example, the paint mark is unwanted on the finished product, there is a lot of maintenance cost in the spaying apparatus, and mostly, grade indication alone is insufficient, additional information is needed such as defect cut instructions.

A long light bar has been used, which is typically a 20 feet long series of led type lights of various colors that is strobed in conjunction with the board travel causing a color indicator that follows the board much like a paint spray without the mess but with the same insufficiencies. However, this type of system cannot be used to convey information by image and there is no possibility of even providing an image on the board with this system. Thus, no feedback of any electronically stored information can be conveyed by this led system

There is a great need for a simple and quick method and system for confirming the accuracy of electronically stored information.

### SUMMARY OF THE INVENTION

An objective of the present invention is to provide an improved method and apparatus to provide quick manual inspection of a piece of lumber to confirm the accuracy of electronically stored information regarding the piece of lumber.

The above objectives and other objectives are obtained by a method of confirming the accuracy of electronically stored information about an individual piece of lumber comprising:
conveying a piece of lumber along a conveyor; and
projecting electronically stored information regarding the piece of lumber onto the lumber through a visual range so that a lumber inspector can confirm the accuracy of the electronically stored information.

The above objectives and other objectives can also be obtained by an apparatus for manually confirming the accuracy of electronically stored information regarding a piece of lumber comprising:
a conveyor constructed to convey a piece of lumber;
at least one projector constructed to project an image onto the piece of lumber moving on the conveyor during use so that the image moves with the piece of lumber through a visual range and is readable by a lumber inspector in the visual range; and
a computer system constructed to determine the location of the piece of lumber on the conveyor and control the projector so that an image projected onto the piece of lumber moves with the piece of lumber, wherein the computer system is constructed to either store electronic information regarding the piece of lumber or receive the electronic information from another source and the image comprises the electronic stored information.

### BRIEF DESCRIPTION OF THE DRAWINGS

FIG. 1 is a top view of the apparatus;

FIG. 2 is a side view of the apparatus; and

FIG. 3 is an example of information projected on lumber.

### DETAILED DESCRIPTION OF THE INVENTION

The invention will now be explained with reference to the attached non-limiting Figures.

Electronic information 16 regarding an individual piece of lumber 2 can be produced by a scanning computer, for example as shown in U.S. Pat. No. 5,412,220 (Moore); U.S. Pat. No. 6,031,567 (Johnson); and U.S. Pat. No. 7,900,663 (Huang) and stored in a scanner computer 4. Alternatively or in addition, the information 16 regarding the individual piece of lumber 2 can be entered by any means as desired, such as manually typing data into the scanner computer 4. Examples of such electronic information 16 include but are not limited to grade, trim information, gate information, type of wood, date, manufacturer, or any other desired information. Preferably, the electronic information 16 is grade. The individual lumber 2 can be in any desired form, such as boards. Preferably, each individual lumber 2 can have an associated electronic information 16.

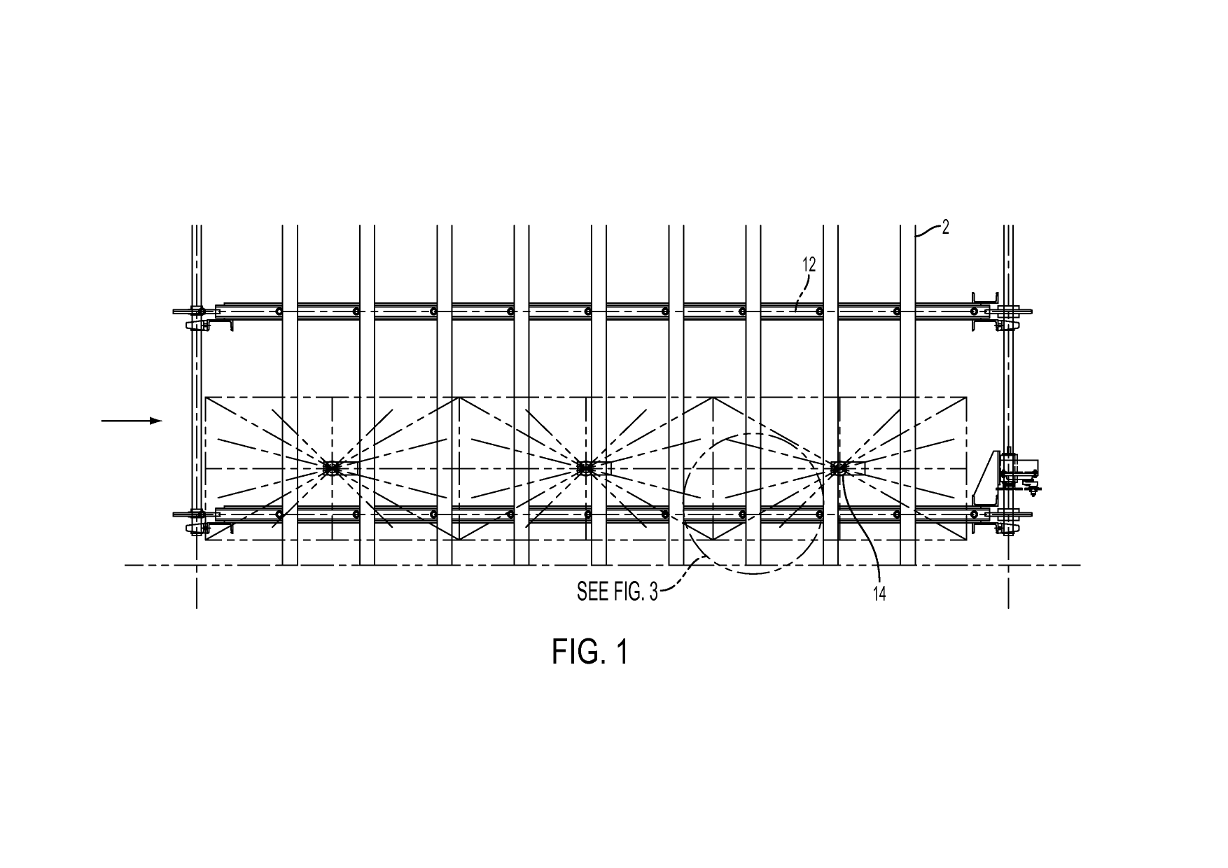

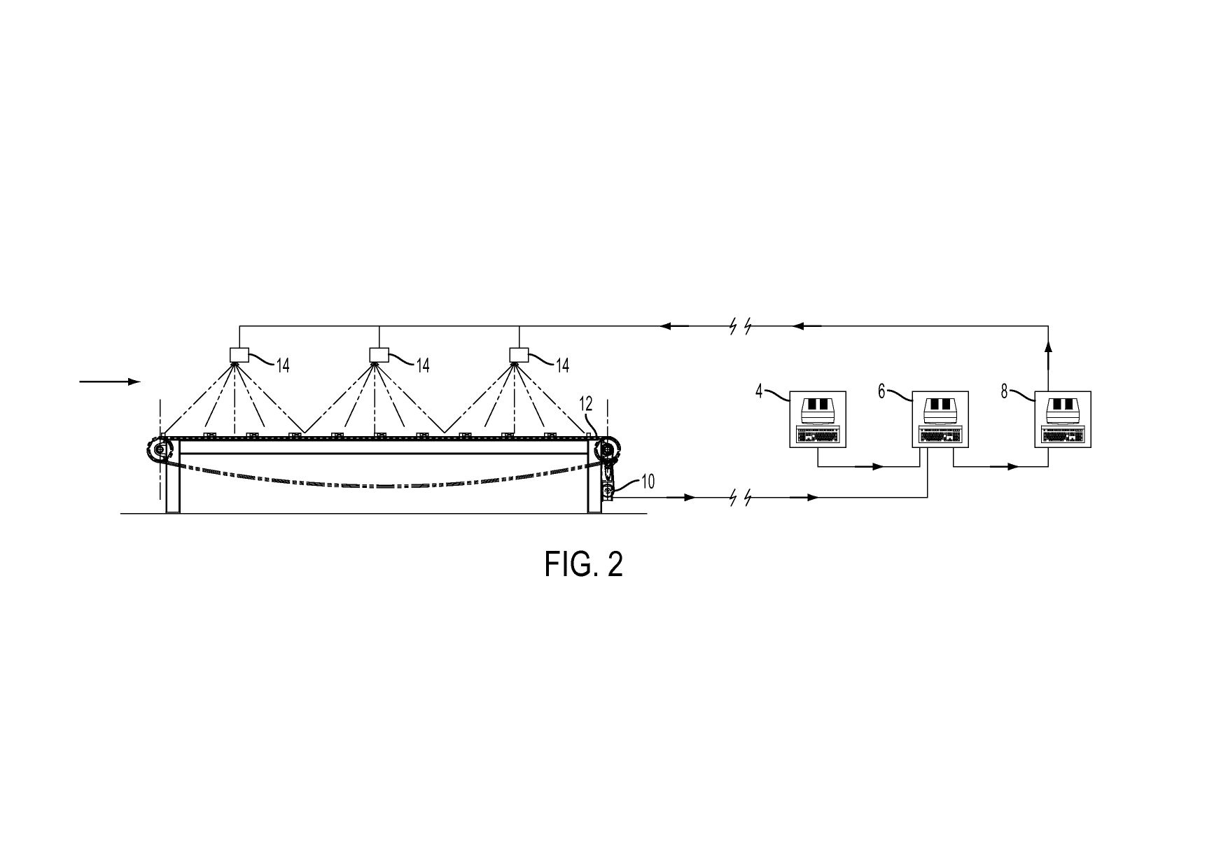

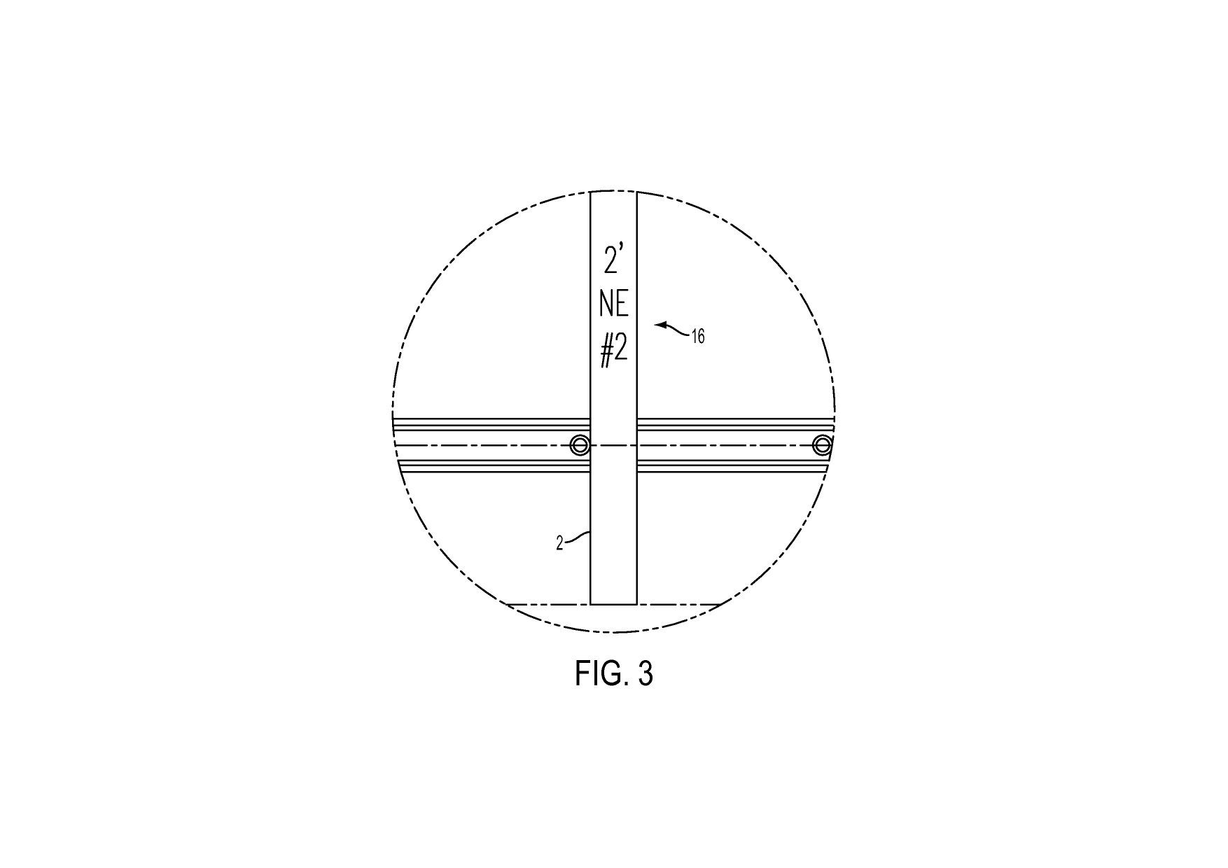

As shown in FIGS. 1-3, in the present invention, the electronic information 16 regarding an individual lumber 2 is transferred from the scanner computer 4 to the system computer 6. The system computer 6 is in communication with a projector computer 8. If desired, the computers 4, 6 and 8 can be a single computer system or any number of connected computer systems. The system computer 6 is connected to a encoder 10 that determines the location of the individual lumber 2 traveling on the conveyor 12. At least one projector 14 is constructed to project an image onto the piece of lumber 2 travelling on the conveyor 12. As the individual lumber 2 passes by or under the projector 14, a visual image of the information 16 relating to the individual lumber 2 is displayed directly on the moving individual lumber 2, as shown in FIG. 3, in such a way as to follow the movement of the individual lumber 2 and be readable to a lumber inspector who can easily and quickly compare the projected information 16 to the individual board 2 to confirm or deny the accuracy of the information 16 stored in the scanner computer 4. When the desired field of view is larger than one projector 14, multiple projectors 14 can be used and the encoded image is programmed from one projector 14 to the next successive projector 14 so that the information 16 is projected on the individual lumber 2 throughout the entire field of view. The projector 14 can be a now well know video projector or a laser projection device. The projector computer 8 can be used to control the projectors 14 in this manner.

The invention also relates to a method of manually confirming the accuracy of the electronic information 16 stored in a scanner computer 4 for an individual piece of lumber 2. The method comprises projecting the information 16 onto the individual piece of lumber 2 as it is being conveyed on a conveyor 12 using at least one projector 14 connected to a projector computer 8. The method also comprises determining the location of the lumber 2 as it travels along the conveyor 12 using a encoder 10 connected to a system computer 6, and transferring location information from the system computer 6 to direct the projector 14 where to project the image of the information 16 so that the image is seen on the individual lumber 2 through a desired field of view. A projector computer 8 can be used to control the projector 14. If desired a single computer or any number of computers can be used to perform the functions of computers 4, 6 and 8. A manual comparison of the projected information 16 can be confirmed with the individual lumber 2. For example, the lumber inspector can inspect an individual lumber 2 and determine the grade. That manually determined grade can be quickly compared to the projected electronic information 16 to confirm or deny the accuracy of the electronic information 16 stored in the scanner computer 4.

While the claimed invention has been described in detail and with reference to specific embodiments thereof, it will be apparent to one of ordinary skill in the art that various changes and modifications can be made to the claimed invention without departing from the spirit and scope thereof.

1. A method of confirming the accuracy of electronically stored information about an individual piece of lumber comprising:
conveying a piece of lumber along a conveyor; and
projecting electronically stored information regarding the piece of lumber onto the lumber through a visual range so that a lumber inspector can confirm the accuracy of the electronically stored information.

2. The method according to claim 1, wherein the electronically stored information comprises the lumber grade, and the method further comprises the lumber inspector comparing a manually determined grade of the piece of lumber to the stored grade projected on the lumber to determine the accuracy of the electronically stored grade of the piece of lumber.

3. An apparatus for manually confirming the accuracy of electronically stored information regarding a piece of lumber comprising:
a conveyor constructed to convey a piece of lumber;
at least one projector constructed to project an image onto the piece of lumber moving on the conveyor during use so that the image moves with the piece of lumber through a visual range and is readable by a lumber inspector in the visual range; and
a computer system constructed to determine the location of the piece of lumber on the conveyor and control the projector so that an image projected onto the piece of lumber moves with the piece of lumber, wherein the computer system is constructed to either store electronic information regarding the piece of lumber or receive the electronic information from another source and the image comprises the electronic stored information.

4. The apparatus according to claim 3, further comprising a scanning computer constructed for storing the electronic information, and the scanning computer being in communication the system computer.

5. The apparatus according to claim 3, further comprising a projector computer constructed to control the projectors, the projector computer being in communication with the system computer.

6. The apparatus according to claim 3, further comprising a plurality of projectors.

7. The apparatus according to claim 3, wherein the projector comprises a laser.

8. The apparatus according to claim 3, wherein the projector comprises a video projector.
